(19) United States
(12) Patent Application Publication
(10) Pub. No.: US 2004/0256857 A1
(43) Pub. Date: Dec. 23, 2004

(54) Aquatic marking lights

(76) Inventor: Robert T. Bailey III, Lakewood, NJ (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/465,516

(22) Filed: Jun. 19, 2003

(51) Int. Cl. H02P 9/04; F03B 13/00; F03B 13/10

(52) U.S. Cl. 290/43

(57) ABSTRACT

A lighting apparatus for use in pools, ponds or other environments includes a series of lights. The lights are powered by a small generator, with no dependence on electricity from external sources, such as nearby outlets or junction boxes. The generator includes a stepper motor having a shaft, and a turbine connected on the shaft. The lights are electrically connected to the stepper motor. The turbine is rotatable with the shaft of the stepper motor to generate an output voltage to illuminate the lights.

### FIELD OF THE INVENTION

The present invention relates to a lighting apparatus and more specifically to lighting systems operated by water-powered or wind-powered generators.

### BACKGROUND

Low voltage lighting systems are frequently used in landscaping to illuminate walkways and enhance the appearance of buildings, gardens or other landscape features. In many cases, the lighting systems are installed and removed by plugging the lights into 120V, 60 Hz electrical outlets, or wiring the lights to junction boxes. Low voltage lighting systems can be difficult to install in or around swimming pools, ponds or other aquatic environments. In pools, for example, the electrical wiring must be grounded and safely covered or concealed. Moreover, electrical outlets and junction boxes are not always located in proximity to the installation. Therefore, lighting systems that require connection to outlets or junction boxes are not ideally suited for aquatic environments or environments that lack a supply of electricity.

### SUMMARY OF THE INVENTION

A lighting apparatus for use in pools, ponds or other aquatic environments includes a series of lights. The lights are powered by a small generator, with no dependence on electricity from nearby outlets or junction boxes. The generator includes a stepper motor having a shaft, and a turbine connected to the shaft. The lights are electrically connected to the stepper motor. The turbine is rotatable by a fluid flow, such as an air current or water flow, to rotate the shaft of the stepper motor and generate an output voltage to illuminate the lights.

In a particular application, the lighting apparatus is installed in a swimming pool having an inflow port or a return that circulates filtered water from and to the pool. The turbine is placed in communication with one of the ports which produces a current that rotates the turbine. The turbine is coupled with the shaft of the stepper motor and is rotatable with the shaft of the stepper motor to generate electric pulses that illuminate a series of light-emitting diodes (LEDs) arranged in the pool. The LEDs are powered solely by the generator, which draws power from kinetic energy in the stream and converts it to electric pulses of current.

### DESCRIPTION OF THE DRAWINGS

The foregoing summary as well as the following description will be better understood when read in conjunction with the drawings in which:

FIG. 1 is a schematic view and block diagram of a lighting apparatus in accordance with the present invention installed in a swimming pool.

FIG. 2 is a partial perspective view of a lighting element used in the apparatus of FIG. 1.

FIG. 3 is a schematic view and block diagram of a lighting apparatus of the present invention installed in a pond.

FIG. 4 is a partial elevational view of the lighting apparatus having a water turbine of the present invention installed on a buoy.

FIG. 5 is a partial elevational view of another configuration of the present invention having an air turbine installed on a buoy.

FIG. 6 is an elevational view of the lighting apparatus of the present invention employing an air turbine.

### DETAILED DESCRIPTION OF THE PREFERRED EMBODIMENT

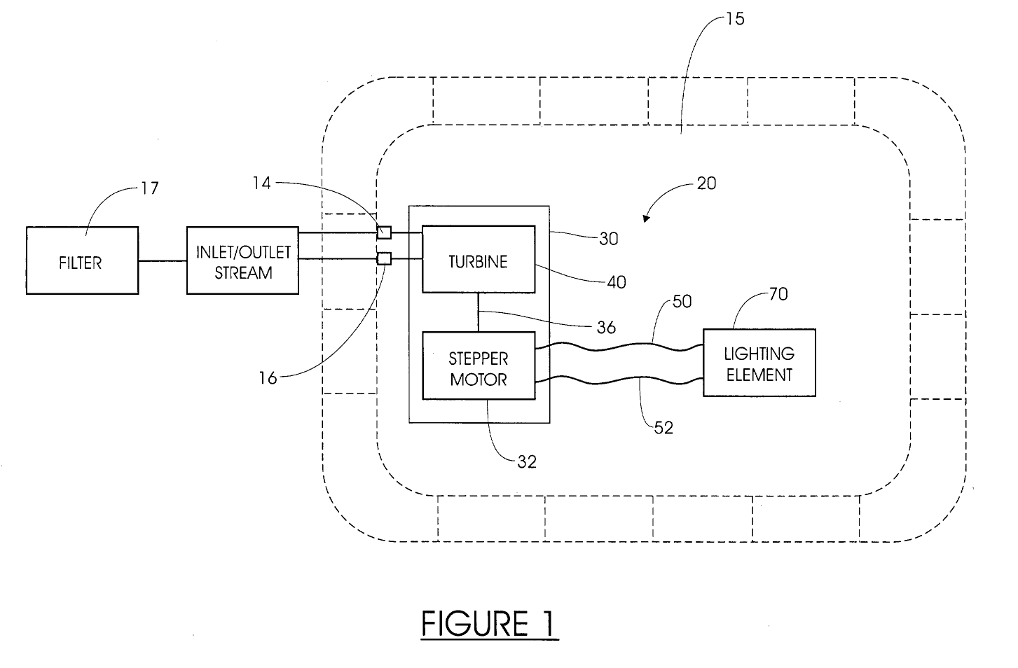

Referring to the drawing figures generally, and to FIG. 1 in particular, a lighting system in accordance with the present invention is shown and designated generally as 20. The lighting system 20 is installed in a swimming pool 15 for illuminating the water in the pool. The lighting system 20 includes a small generator 30 that converts kinetic energy from flowing water in the pool to electrical pulses of current to illuminate a series of lights. The lights are powered by the generator 30 and require no connection to electrical outlets, junction boxes, battery packs, or other sources of electrical power. As such, the lighting system is inexpensive and safe to operate, without the costs and safety issues that arise when power is drawn from electrical outlets, junction boxes or battery packs.

The lighting system 20 may be configured in a variety of ways to draw power from the flow of water in the pool. For example, the generator 30 may be configured to convert kinetic energy from turbulent currents in the pool created by swimmers. Alternatively, the generator 30 may be configured to convert kinetic energy from water discharged into the pool or drawn from the pool from the pool's filter system 17. In FIG. 1, the swimming pool 15 includes a filter unit that draws pool water through a pool outlet 14 leading to the filter 17 and discharges the pool water in a return stream that enters the pool through an inlet 16 to the pool. The generator 30 is mounted in proximity to at least one of the inlet 16 and the outlet 14 and comprises a stepper motor 32 having a rotatable shaft 36. The shaft 36 has a first end connected to the stepper motor 32 and a second end that extends outwardly from the stepper motor. The second end of the shaft 36 extends relative to at least one of the inlet stream to the pool filter or the return stream from the inlet 16 in an orientation that is generally normal to the direction of flow in the stream. A turbine, such as a paddle wheel 40, is coupled, either directly or indirectly through a suitable belt and pulley arrangement or a suitable gear arrangement, with the second end of the shaft 36 and extends, for example, into the stream. The turbine 40 has a plurality of blades or paddles arrayed about the circumference of the shaft that face into the stream. The paddles are displaceable in response to contact with the stream to continuously rotate the turbine 40. The shaft 36 is coupled with the turbine 40 and rotates in unison with the turbine. The shaft 36 is configured to transfer torque from the rotating turbine 40 to the stepper motor 32. As such, shaft 36 of the stepper motor 32 is rotatable with the turbine 40 under the kinetic energy supplied by the stream.

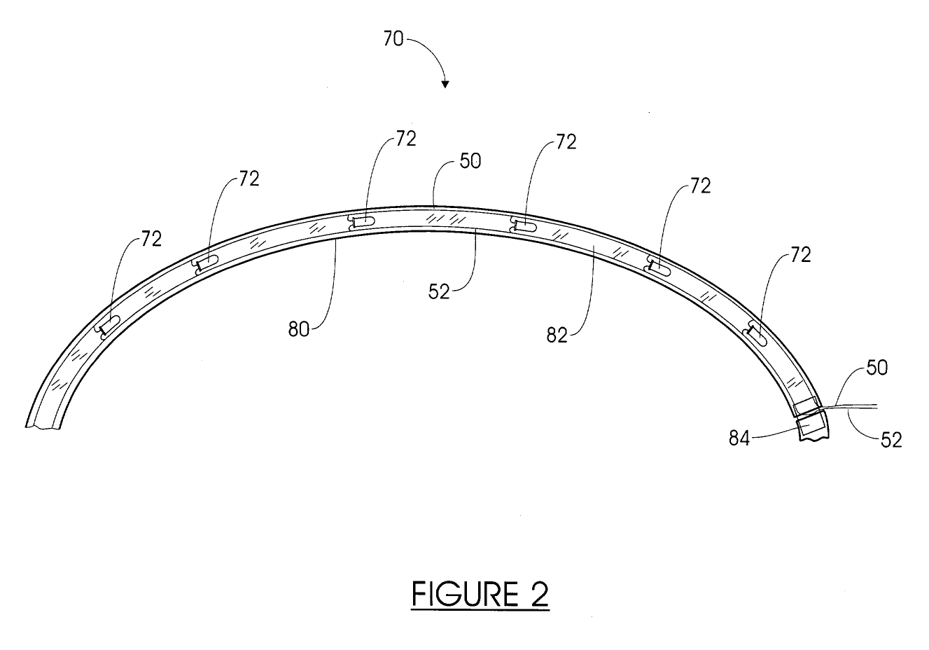

The stepper motor 32 is rotatable to generate a suitable output voltage. A pair of wires 50, 52 extend from the stepper motor 32 and connect the stepper motor to a lighting element 70. Referring to FIG. 2, a section of a lighting element 70 comprises a series of lights that are operable to illuminate the pool 15. A variety of light sources may be used. In FIG. 2, the lighting element 70 contains a series of LEDs 72 connected in a parallel circuit. Pulses of current generated by the stepper motor 32 alternate the polarity through the circuit. The alternating polarity periodically exceeds the threshold voltage of the LEDs 72, at which time the LEDs are illuminated.

The LEDs 72 and wires 50, 52 may be housed in a transparent or translucent hollow tube 80 having a pair of ends which may be open or sealed depending, for example, on a specific location of installation. If the light tube is installed at, near, or in the water, the ends of the tube may be sealed to prevent the intrusion of water into the tube. The tube 80 forms a protective enclosure to protect the LEDs and wires from damage caused by shocks and severe impacts. In a specific configuration, the open ends of the tube may be sealed by a plug 84 formed of a molded resinous or other resilient material that is partially inserted in each end of the tube 80 to engage the interior of the tube ends to hold the tube ends together and form a closed loop. The wires 50, 52 extend from the stepper motor 30 through the side of the plug 84 and into the tube 80 to connect with the LEDs 72. Preferably, the plug forms a fluid tight seal in each tube end. Alternatively, the tube may be sealed separately at each end so that the tube can be bent or formed into an appropriate shape such as a straight line, an S-shaped path, or along a selected contour of the pool.

The tube 80 may be formed of a variety of plastics that are flexible to permit the tube to be arranged in different shapes in the pool 15. In the preferred embodiment, the tube 80 is filled with a clear viscous liquid 82, such as glycerine, which provides an additional shock absorbing cushion around the LEDs 72. A variety of optional features may be used with the lighting element 70 to provide different visual effects when the lights are illuminated. For example, the tube wall may be tinted or colored so that light emitted through the tube wall appears as colored light. Alternatively, the liquid 82 may contain a coloring agent to provide a colored appearance through the tube. The liquid 82 may also contain glitter or other materials suspended in the liquid that reflect or refract light from the LEDs and produce a unique visual effect.

The flexible tube 80 may be manipulated in a variety of shapes to conform to the dimensions of different pools. For example, the tube 80 may be placed around the perimeter of a pool at the water line to create a visual effect on the surface of the water. The tube 80 may be secured to the side wall of the pool, or float freely at the pool's edge.

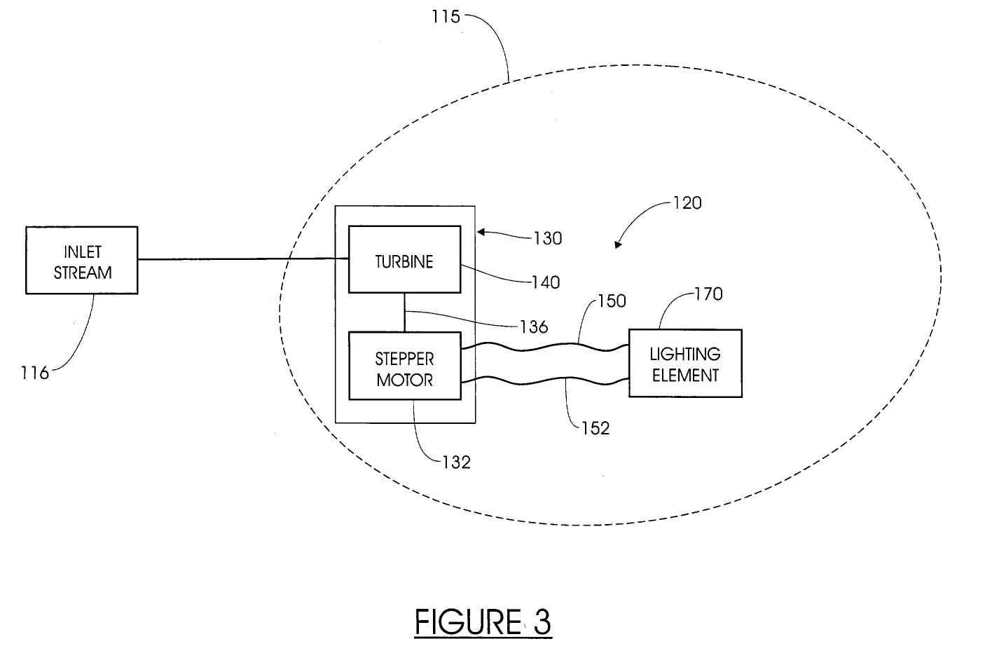

Referring now to FIG. 3, a lighting system 120 is placed in a stream-fed pond 115 and operates to illuminate the pond. The lighting system 120 generally operates in the same manner as the light system described for use in swimming pools, except that the lighting system 120 is powered by an influent stream 116 that feeds the pond 115 or by an effluent stream draining from the pond. A small generator 130 converts kinetic energy from the stream 116 into electrical pulses of current operable to illuminate a lighting element 170. The generator 130 comprises a stepper motor 132 and a turbine 140, such as blades or paddle wheel 140, coupled with the stepper motor by a shaft 136. The turbine 140 rotates with the shaft 136 under hydraulic power provided by the stream. The shaft 136 transfers torque to the stepper motor 132 to rotate the shaft of the stepper motor to generate an output voltage. The shaft 136 may include the shaft of the stepper motor, or the shaft 136 may be coupled with the shaft of the stepper motor, such as by a suitable belt or gear arrangement. A pair of wires 150, 152 connect the stepper motor 132 to the lighting element 170. Current passes through the wires 150, 152 to illuminate the lighting element 170. As stated earlier, a variety of light sources may be used, including a series of LEDs. The lighting system 120 may include a transparent tube, a viscous fluid, and any of the optional features described in connection with the pool lighting system.

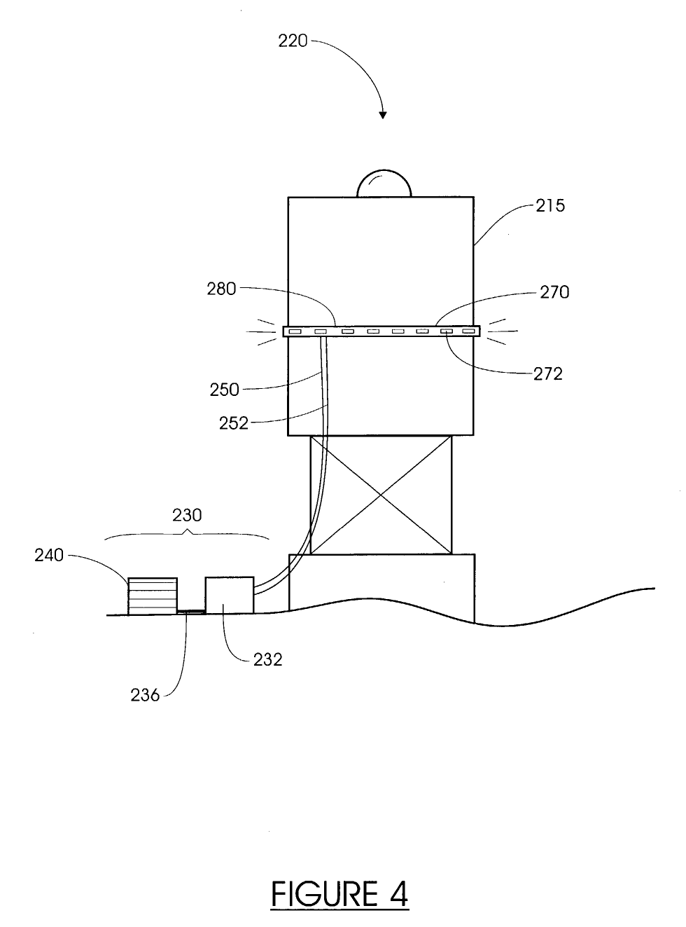

Referring to FIG. 4, a light system 220 is mounted on a buoy 215 which floats on a body of water and supports the light system 220. The light system 220 shown in FIG. 4 is similar to light systems 20 and 120 and may include the various features of such light systems. A small generator 230 is operable to illuminate a series of lights on the buoy 215 to provide, for example, a marine marking light for marine vessels. The generator 230 includes a turbine 240, such as blades or a paddle wheel, that contacts the surface of the water, or is submergible into the underwater currents, to convert kinetic energy from passing currents into electrical current to illuminate the lights. In this way, the lighting system can be operated indefinitely without battery power.

The generator 230 comprises a stepper motor 232 and a turbine or paddle wheel 240 connected to the stepper motor by a shaft 236. The turbine 240 is placed in contact with currents or eddies in water surrounding the buoy 215. The turbine 240 may have a plurality of blades arrayed about the circumference of the shaft 236 that contact the water surface. The blades are displaceable in response to water currents which move past the buoy 215 to rotate the turbine 240. The shaft 236 is coupled with the turbine 240 and rotates in unison with the turbine. The shaft 236 is configured to transfer torque from the rotating turbine 240 to the stepper motor 232.

The shaft 236 transfers torque to the stepper motor 232 to generate an output voltage. A pair of wires 250, 252 connect the stepper motor 232 to a lighting element 270 mounted on the buoy 215. Electrical current passes through the wires 250, 252 to illuminate the lighting element 270. The lighting element 270 may contain a series of LEDs 272 connected in a parallel circuit. Preferably, the lighting element 270 and wires 250, 252 are housed in a transparent tube 280 and are surrounded by a viscous fluid to protect the LEDs from damage, as discussed in connection with the pool and pond lighting systems.

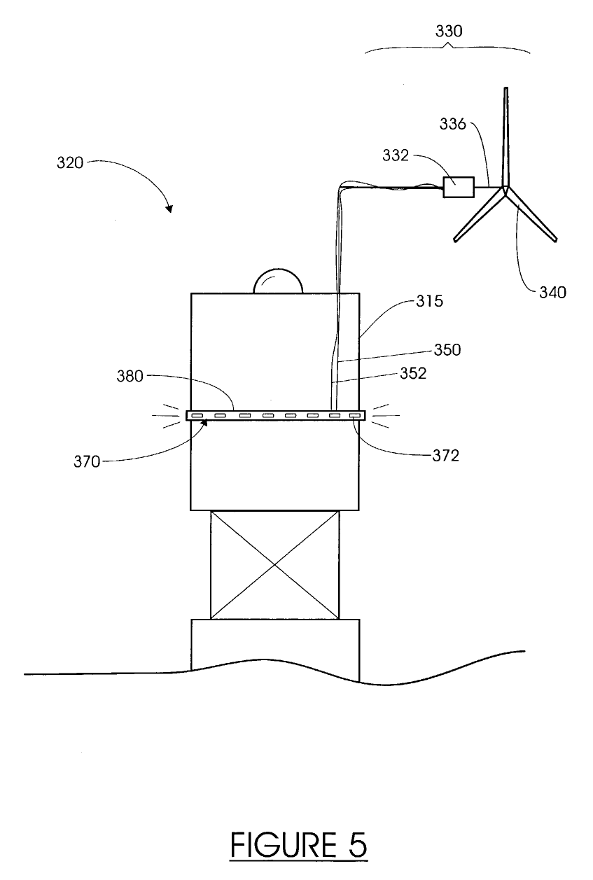

Referring to FIG. 5, a light system 320 is mounted on a buoy 315 which floats on a body of water, similar the marine marking light system 220 described above. The light system 320 shown in FIG. 5 may be used in conjunction with the light system 220 shown in FIG. 4. The light system 320 has a light element 370 powered by a generator 330 that converts kinetic energy from passing winds into electrical current. The generator 330 comprises a small windmill air turbine 340 having a plurality of blades that rotate in response to passing winds. The turbine 340 is connected to a stepper motor 332 by a shaft 336. The shaft 336 may include the shaft of the stepper motor 332 or may be coupled therewith so that the shaft of the stopper motor rotates with the turbine 340 to generate an output voltage. A pair of wires 350, 352 connect the stepper motor 332 to a lighting element 370 mounted on the buoy 315. Electrical current passes through the wires 350, 352 to illuminate the lighting element 370. The lighting element 370 contains a series of LEDs 372 connected in a parallel circuit. The LEDs 372 and wires 350, 352 are preferably housed in a transparent tube and are surrounded by a viscous fluid to protect the LEDs from damage, as discussed above in connection with the pool and pond lighting systems.

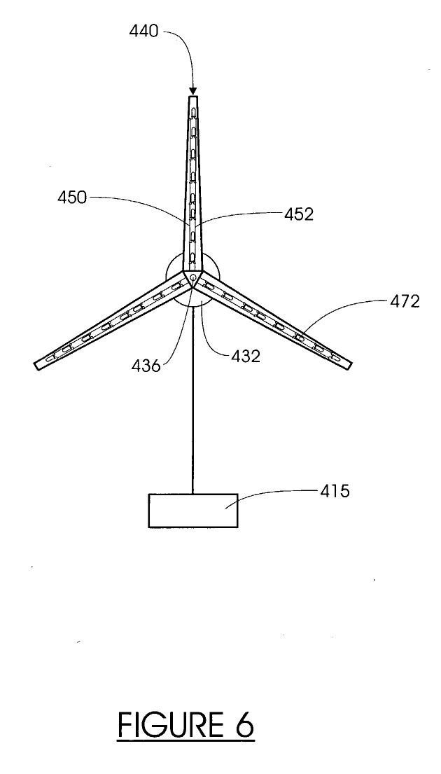

The lighting apparatus of the present invention is intended for a variety of uses. The lights may be mounted in a variety of different configurations and locations to perform a desired effect. For example, lights may be mounted directly to the blades on a windmill turbine for use on buoys. Referring to FIG. 6, a windmill turbine 440 is shown mounted on a base 415 and connected to a shaft 436. The turbine 440 has a plurality of blades arrayed circumferentially about the shaft 436. The turbine 440 is rotatable with the shaft 436 in response to winds that contact the turbine blades. The shaft 436 couples the turbine 440 to the shaft of a stepper motor 432 that rotates with the turbine to generate an output voltage. The shaft 436 of the turbine may in fact be the shaft of the stepper motor, or, alternatively, may be coupled indirectly to the shaft of the stepper motor. A pair of wires 450, 452 connect the stepper motor 432 to a plurality of LEDs 472 mounted on each turbine blade. Electrical current passes through the wires 450, 452 to illuminate the LEDs as the turbine 440 rotates. If desired, the turbine blades may be formed of or covered with a reflective material, such as aluminum, to reflect and disperse light rays from the LEDs.

The terms and expressions which have been employed are used as terms of description and not of limitation. There is no intention in the use of such terms and expressions of excluding any equivalents of the features shown and described or portions thereof. It is recognized, therefore, that various modifications are possible within the scope and spirit of the invention. Accordingly, the invention incorporates variations that fall within the scope of the following claims.

I claim:

1. A lighting apparatus for a body of water having a stream, said lighting apparatus comprising:
A. a stepper motor mounted in a fixed position relative to the stream, said stepper motor having a shaft;
B. a turbine coupled with the shaft of the stepper motor, said turbine extending from the stepper motor into the stream; and
C. a plurality of light-emitting diodes electrically connected to the stepper motor,
wherein, the flow of water in the stream is operable to rotate the turbine as the stream passes the turbine, said turbine being rotatable with the shaft of the stepper motor to generate electric pulses that illuminate the light-emitting diodes.

2. The lighting apparatus of claim 1, further comprising a flexible tube that houses the light-emitting diodes.

3. The lighting apparatus of claim 2, wherein the tube is filled with a viscous fluid that surrounds the light-emitting diodes.

4. The lighting apparatus of claim 1, wherein the body of water comprises a swimming pool having a flow stream for a filter unit, and the lighting apparatus is configured for mounting the turbine in the flow stream.

5. The lighting apparatus of claim 1, wherein the body of water comprises a pond with a stream, and the turbine is configured for placement in the stream.

6. A marine marking apparatus for use in a body of water, said marking apparatus comprising:
A. a floating buoy;
B. a plurality of light-emitting diodes supported relative to the buoy;
C. a stepper motor supported relative to the buoy, said stepper motor having a shaft; and
D. a water turbine coupled with the shaft and rotatable with the shaft to rotate the shaft of the stepper motor, said water turbine extending from the stepper motor into the body of water and rotatable in response to a water current,
wherein, the shaft of the stepper motor is rotatable in response to rotation of the water turbine to generate electric pulses that illuminate the light-emitting diodes for the buoy.

7. The marine marking apparatus of claim 6, comprising a flexible tube that houses the light-emitting diodes, said tube being supported at the exterior of the buoy.

8. The marine marking apparatus of claim 7, wherein the tube is filled with a viscous fluid that surrounds the light-emitting diodes.

9. The marine marking device of claim 6, comprising an air turbine coupled with the shaft and rotatable with the shaft to rotate the shaft of the stepper motor, said air turbine extending outwardly from the buoy in a position exposed to winds.

10. A marine marking apparatus for use in a body of water, said marking apparatus comprising:
A. a floating buoy;
B. a plurality of light-emitting diodes supported relative to the buoy;
C. a stepper motor supported relative to the buoy, said stepper motor having a shaft; and
D. an air turbine coupled with the shaft and rotatable with the shaft to rotate the shaft of the stepper motor, said air turbine extending outwardly from the buoy in a position exposed to winds,
wherein the air turbine is rotatable in response to the winds to rotate the shaft of the stepper motor to generate electric pulses, said electric pulses being operable to illuminate the light-emitting diodes.

11. The marine marking apparatus of claim 10, comprising a flexible tube that houses the light-emitting diodes, said tube being secured around the exterior of the buoy.

12. The, marine marking apparatus of claim 11, wherein the tube is filled with a viscous fluid that surrounds the light-emitting diodes.

13. An illuminated marker, comprising:
A. a support;
B. a turbine rotatably mounted on a shaft extending from the support, said turbine having a plurality of blades;
C. a stepper motor connected with the shaft and rotatable with the turbine in response to wind force acting on the turbine blades; and
D. a plurality of light-emitting diodes disposed on the turbine blades and electrically connected to the stepper motor,
wherein, rotation of the turbine is operable to actuate the stepper motor to generate electric pulses, said electric pulses being operable to illuminate the light-emitting diodes on the turbine blades.

14. The illuminated marker of claim 13, wherein each turbine blade comprises a hollow tube that houses the light-emitting diodes.

15. The illuminated marker of claim 14, wherein the tubes are filled with a viscous fluid that surrounds the light-emitting diodes.

16. The illuminated marker of claim 13, wherein the turbine blades each comprise a reflective surface configured to disperse light rays that are emitted from the light-emitting diodes.
